(19) United States
(12) Patent Application Publication
(10) Pub. No.: US 2003/0038721 A1
(43) Pub. Date: Feb. 27, 2003

(54) System and method for automatic, redundant recording of animal injection information

(76) Inventor: Thomas Hogan, Powder Springs, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/178,943

(22) Filed: Jun. 24, 2002

Related U.S. Application Data
(63) Continuation-in-part of application No. 09/832,385, filed on Apr. 11, 2001.
(63) Continuation-in-part of application No. 10/128,132, filed on Apr. 23, 2002.
(63) Continuation-in-part of application No. 10/093,856, filed on Mar. 7, 2002.
Application No. 10/093,856 is a continuation-in-part of application No. 09/477,262, filed on Jan. 4, 2000, now Pat. No. 6,401,071.

(51) Int. Cl. G08B 23/00

(52) U.S. Cl. 340/573.3; 340/572.1; 340/572.8; 340/5.8; 235/435; 235/487; 119/51.02

(57) ABSTRACT

A system and method for automatic, redundant recordation of information relating to administration of medicines to animals are accomplished by a transceiving syringe simultaneously injecting and marking an animal, receiving identification information from a read/write radio frequency identification device attached to the animal and containing identification information relating to the animal, associating the injection and identification information, and then routing the event information to both a database and back to the RWRFID for storage.

### PRIORITY

This application is a continuation-in-part of pending U.S. patent application Ser. No. 09/832,385, filed Apr. 11, 2001, and entitled “Tamper-Proof Animal Identification Tag,” and U.S. patent application Ser. No. 10/128,132, filed Apr. 23, 2002, which is a continuation-in-part of U.S. patent application Ser. No. 10/093,856, filed Mar. 7, 2002, which is a continuation-in-part of U.S. Pat. No. 6,401,071, filed Jan. 4, 2000, which are all entitled “System and Method for Automatically Recording Animal Injection Information,” the disclosures of which are incorporated herein by reference.

### TECHNICAL FIELD

The present invention relates to systems and methods for automatic, redundant recording of information relating to animal injections. More particularly, the present invention relates to a system and method for the combined, coordinated and automatic recordation of animal injection and identification information into both a computer database and onto a storage device.

### BACKGROUND INFORMATION

The regular and accurate administration of medicine to animals such as hogs and cattle is critical to the physical health of the animals, the resulting quality of the food products the animals deliver, and the sense of confidence the consumer has in the wholesomeness of those food products. These concerns are equally prevalent in both the cattle and hog industries, so it will be understood and appreciated that the following references to cattle, made for illustrative simplicity, are equally applicable to hogs.

In cattle, vast numbers of different, complex medicinal regimens have been developed and implemented in an effort to generate healthier animals that produce a safe, higher quality and quantity of beef. Because slaughtered beef is valued, in significant part, on its quality characteristics, and because the premium paid for high quality beef is high (the Choice: Select spread often runs $10-$14 per cwt. therefore on a 650 lbs. carcass the difference in value can be $65-$91 per carcass), those raising cattle for profit remain in search of the optimum medical regimen. Furthermore, pharmaceutical companies almost blindly spend billions of dollars developing individual medicines without the opportunity or resources to conduct a large-scale, extended length individual animal-based field tests. Compounding the problem is the fact that current systems and methods of record keeping among cattle ranchers and pork producers fail to provide the kind and volume of high quantity, high integrity information about the effects of various medicines on individual animals that would alert pharmaceutical developers of the most likely avenues for future successful drug development. Additionally, the growing concerns by consumers over the residual effects of the application of these medical treatments (as they relate to food safety) are not satisfied by any present method or system for medical treatment tracking or accounting.

Numerous advances in the medicine delivery systems have helped cattlemen gain increased control over the historically chaotic task of administering medicines to animals. Notably, my U.S. Pat. No. 5,961,494, which is specifically incorporated herein by reference, discloses a marking syringe which, when actuated, simultaneously injects medicine into an animal and places a mark on the skin of the animal in proximity to the location of the injection. This marking syringe (known commercially as the “VAC-MARC”) cleverly reduces what was formerly a clumsy, two-step injecting and marking process into one step—the actuation of the syringe. Nonetheless, a cattleman using the marking syringe taught by the '494 patent and desiring to maintain records of injections would still have to somehow identify the animal and then manually record the fact that that particular animal had been injected.

Beyond the logistics of injecting and marking an animal, proper identification of the animal is also important to not only inventory but disease tracking and control. In this regard, it is well known to skilled cattlemen that an electronic identification device (EID), often implemented in the form of an ear tag, can be used to electronically identify animals such as cattle. Such EIDs are well known in the industry and are produced by companies such as Allflex, USA, 2805 W. 12^{th} Street, Dallas, Tex. 75211-0270, (972) 456-3686, www.allflexusa.com; Y-Tex Corporation, P.O. Box 1450, Cody, Wyo., 82414, www.ytex.com; and MagTrac, 3203 Third Avenue North, Billings, Mont., 59101, (406) 252-6690. Ear tags such as those available through these channels can be attached to the animal and will normally remain so attached for the life of the animal. The EID, if active, transmits a signal which can be read by either a stationary or hand-held reader. If passive, the EID can be triggered to transmit an identification signal by a trigger signal transmitted by another signal source. Once the trigger signal is recognized by the EID, the EID transmits a responsive identification signal.

Innovative systems have been implemented that allow incorporation of the advantages of identification by EID with the advantages of automatic marking syringes. Notably, my U.S. Pat. No. 6,401,071, which is specifically incorporated herein by reference, discloses a revolutionary system and method for automatically identifying an animal upon delivery of an injection to the animal, and recording both the identity of the animal and the occurrence of the injection in a computer database.

While such a system is revolutionary, it is not without room for improvement. In particular, when information relating to animal injections is recorded in the computer or PDA, the storage location for the information is usually remote from the injection arena, and may be located off-site altogether. If a rancher or veterinarian, while on the ranch and while observing a particular animal, desires the medical history of a particular animal, he must return either to the farm office where such information may be stored locally, or where he can access a remote database by modem or other similar means. Requiring such effort to obtain information on a particular animal causes unnecessary delay in developing a complete assessment of the animal's health, and may even be a deterrent to reviewing such information before determining a future medical regimen. Such factors could have a significant, negative consequence on the health of the animal.

Further, it stands to reason that if the stored animal injection information is in any way corrupted by a memory failure, virus, etc., it would be of paramount importance to have a separate back-up system for the data.

Accordingly, there is a need for a system and method in which information relating to the administration of medicines to animals can be quickly accessed, during inspection of an animal, without returning to a home office and without accessing a remote database.

There is a further need for a system and method for providing a reliable, automatic back-up of animal injection information that is isolated from conventional storage mechanisms and, therefore, protected from compromise of such conventional storage mechanisms.

### BRIEF SUMMARY OF THE INVENTION

The present invention relates to a novel system for automatic, redundant recordation of information relating to administration of medicines to animals.

A preferred embodiment of the invention implements a transceiving syringe for simultaneously injecting and marking an animal while transmitting, responsive to actuation of the transceiving syringe, a first signal containing information relating to the actuation of the transceiving syringe and the resulting injection of the animal. Additionally, an electronic identification device (EID) such as a read/write radio frequency identification device (RWRFID) is attached to the animal for providing a tamper-resistant electronic identification of the animal. Additionally, a receiver is implemented to receive both the first signal from the transceiving syringe and the electronic identification of the animal, as provided by the EID.

After receipt of the respective signals by a receiver, the signals are maintained in a computer database for review and analysis.

### BRIEF DESCRIPTION OF THE DRAWINGS

FIG. 1 depicts an exemplary embodiment of the present invention in an exemplary operating environment.

FIG. 2 depicts an exemplary environment for implementation of an aspect of the present invention.

FIG. 3 is a flow diagram detailing exemplary steps in performing the method of the present invention.

### DETAILED DESCRIPTION

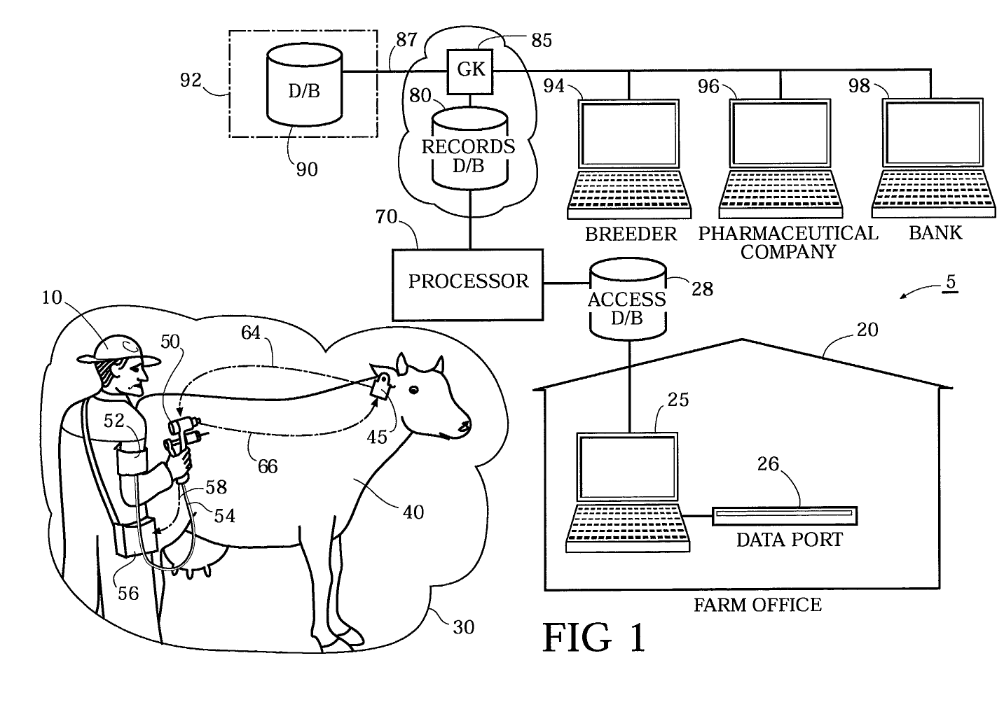

Referring now to the drawings, FIG. 1 depicts an exemplary embodiment of the present invention in an exemplary operating environment. More specifically, the Automatic Injection Recordation System 5 (hereinafter referred to as the “System”) features logistical and procedural devices by which a cattleman 10 can operate out of a farm office 20 in a particularly remote injection arena 30 to deliver injections to an animal 40 and, importantly, automatically record data (also referred to as “information”), relating to the injections, both in a computer database and on a device such as a read/write radio frequency identification device (RWRFID) 45 located on the animal 40.

In operation, the cattleman 10 begins operation of the System 5 by entering identification data such as personal identification information into a personal computer (“PC”) 25 in or near his farm office 20. Depending on the desires of the system administrators, different levels and types of information or security clearances may be required of the cattleman 10 before the cattleman 10 is authorized for further use of the System 5. Determination as to authorization may be made by comparison of information requested of the cattleman 10 to information maintained in a database such as the access database 28. Information contained in the access database 28 relating to authorization criteria for cattlemen could originate from any of a wide variety of sources such as a system administrator, drug manufacturer, or the like.

As far as the specifics of authorization are concerned, it may be sufficient for the cattleman 10 to enter an indicator of his personal identity, such that verification as to his training relating to the System 5 can be verified. It is understood that a substantial aspect of the value of information derived from operation of the System 5 is the guarantee that the information is devoid of errors which may originate with operation by untrained or improperly trained cattlemen. Verification that a particular cattleman has training sufficient to operate the system properly and, therefore, produce reliable data is considered valuable.

Beyond verification that a particular cattleman is properly trained for operation of the System 5, it may also be desirable to require the cattleman 10 to enter into the system, for authorization, the specific medical regimen about to be applied by the cattleman 10 to the animal 40. Determination as to what particular medical regimen is about to be applied to the animal can be made by any number of methods, including manually entering information such as the type of medicine involved, or, in more sophisticated systems, scanning with a bar-code reader a bar-code label on a particular bottle of medicine.

Clearly, if the cattleman 10 is not authorized, by virtue of a lack of training or certification, to deliver a particular medical regimen, the System 5 may not have authority to prevent such delivery. However, because of the cattleman's lack of training or certification, introduction of medical delivery information derived from the activities of an untrained cattleman into the body of data produced by the present invention may have a diminishing effect on the otherwise robust data body. In such a situation, the System 5 would simply not record data relating to medicines delivered by an improperly trained or certified cattleman. Furthermore, it will be understood and appreciated that other discriminators, above and beyond the identity and training of a particular cattleman, may be used to determine whether or not information relating to an instant medical delivery is to be introduced into the body of data.

If the cattleman 10 is authorized to use the System 5 and, additionally, meets any other criteria or discriminators put in place by the system administrator, the system may then be primed by application of electrical power to necessary subsystems and components, such as those in the injection arena 30.

In preparation for an injection session, the cattleman 10 accesses and prepares for use a syringe such as a transceiving syringe 50. The transceiving syringe 50 is a syringe having the ability to simultaneously deliver an injection to the animal 40, deliver a marking ink spot to the animal 40, receive identification information from the RWRFID 45 attached to the animal 40, relay identification information 64 relating to the animal and injection information relating to the delivery of the injection to a database as “event information”, and transmit the event information to the RWRFID 45 for storage thereon.

Many of the essential functions of the transceiving syringe 50 are known to those skilled in the prior art, in large part because of the disclosure thereof in a number of patent applications and issued patents to the inventor herein. Specifically, U.S. Pat. Nos. 5,961,494 and 6,264,637 are directed to marking syringes. U.S. Pat. No. 6,401,071 is directed to a system and method for automatically recording animal injection information, and fully sets forth the basic concept of simultaneously injecting an animal and recording the occurrence of the injection and the identity of the animal. Moreover, my '071 patent has given rise to multiple continuation applications, each of which have advanced the state of general knowledge regarding injection and information systems of this nature. Each of these patents are specifically incorporated by reference herein.

In a preferred embodiment of the present invention, the transceiving syringe 50 is connected to a medicine reservoir 52 via a medicine conduit 54. It is foreseen that many medical administrations will be of such a small amount, by volume, that the cattleman 10 can retain the medicine reservoir 52 on an arm, leg, or in a backpack-type retention device, for ease of mobility about the injection arena. For example, my U.S. Pat. No. 5,911,709, which is incorporated herein by reference, discloses a vaccine pack which contains and maintains vaccine at a constant temperature. In cases where it is not incorporated, the medicine conduit 54 is a flexible, tubular member securely interconnected between the transceiving syringe 50 and the medicine reservoir 52. As is well known to those skilled in the administration of medicines to animals, all medicine delivery components must comport with relevant health and safety regulations, especially in view of the highly toxic nature of many such medicines.

In preparation for commencement of animal injections, the cattleman 10 may also place a personal data device (“PDD”) 56 on his person for recording injection information as will be described momentarily. It will also be understood that the spirit and scope of the present invention specifically contemplates transceiving syringes which, themselves, carry a sufficient amount of medicine to accomplish a desirable number of injections, without requiring either a detached medicine reservoir 52 or a medicine conduit 54.

Now that the System 5 is activated by registration of an authorized user such as the cattleman 10 administering a medical regimen he is authorized to administer, and the necessary medicine delivery components 50, 52 and 54 are in place, an animal 40 is moved into the injection arena 30.

The robustness of the information ultimately derived from the System 5 relies, in significant part, on the reliable linkage between a particular animal such as animal 40 and the injection data derived from delivery of an injection to the animal 40. To such end, a reliable animal identification device such as the RWRFID 45 is attached to the animal 40. As is well known to those familiar with animal identification techniques, the RWRFID 45 is typically a passive magnetic device which is normally attached to an ear of an animal, but can also be deposited in the rumen (stomach) of the animal by swallowing, or placed under the skin of the animal in an anticipatable location.

Generally, the passive RWRFID 45 emits a detectable electrical signal upon stimulation by a stimulus signal. The electrical signal is unique to the particular animal to which the RWRFID 45 is attached, and accurate detection of the signal provides an equally accurate identification of the animal.

In an embodiment of the present invention, transmission of a stimulus signal (not shown) by a well-known stimulus signal generator incorporated into the transceiving syringe 50 excites the RWRFID 45 to generate responsive identification information 64. A receiver is functionally incorporated into the transceiving syringe 50 and detects the identification information 64, which contains the identity of the animal. After detection of the identification information 64, the transceiving syringe 50 stores the identification 64 until the identification information 64 can be associated with injection information from the injection of the animal.

As the cattleman 10 delivers the injection to the animal 40 by actuating the transceiving syringe 50, an ink mark is placed on the animal 40 in close proximity to the location of the injection and, importantly, an injection information is generated by the transceiving syringe 50 which verifies that a particular injection has taken place. After the injection has taken place, the injection information and the identification information 64 are linked or “associated” into a single event information record so that a verifiable record exists which demonstrates that a particular injection was administered to a particular animal.

Once the event information has been created, it is delivered to two different locations. The event information is relayed to a computer database. It will be understood and appreciated that the term “computer database” should be broadly construed to include many forms of data storage elements capable of either short-term or long-term storage of such date. For example, a computer database may be a device such as the PDD 56 maintained on or near the person of the cattleman 10. In such a situation, the transceiving syringe 50 may be attached to the PDD 56 either by a physical connection means such as a wire or cable, or they may be wirelessly connected. For example, actuation of the syringe 50 generates an injection signal 58 to be received by the PDD 56. In either situation, the transceiving syringe 50 relays the event information to the PDD 56 for storage until the cattleman 10 finds a convenient opportunity to connect the PDD 56 to a computer 25 by way of a data port 26 (also known as a “docking station”), from which the event information can be relayed to a remote database such as database 90, in a manner later described.

Alternately, the PDD 56 may be capable of making a direct connection (via internal modem or wireless means) to the database 90 without the need for the computer 25 or data port 26.

Yet another iteration of this basic principle is the location of the functionality of the PDD 56 within the transceiving syringe 50 itself. In this configuration, there is no requirement for the cattleman 10 to carry an extra electrical device with him. On the other hand, adding this functionality to the transceiving syringe 50 will likely increase the weight of the syringe, possibly making this arrangement less than optimal for certain applications.

In reasonable proximity, time wise, to the completion of the injection and the routing of the injection information to a computer database, the transceiving syringe 50 also transmits the event information, which includes the combination of the identification information 64 and the injection information, to the RWRFID 45 via event information signal 66. The RWRFID 45 receives the event information signal 66 and stores it in memory located on the RWRFID 45, itself.

As devices for transmitting, receiving and storing relatively low-power and low data content RF signals such as identification information 64 and event information signal 66 are abundantly available and well known to those skilled in the art, no further explanation of such mechanisms is needed.

Periodically, the event information gathered in accordance with the above specified system is delivered, through any of the above-discussed arrangements, through the processor 70 to a records database 80 for storage and access by authorized users. Control over access to the records database 80 is maintained by a gatekeeper 85. Gatekeepers such as gatekeeper 85 are well known in the data management industry and simply require an individual desiring access beyond the gatekeeper to provide a key, PIN, code word, or other information so that passage beyond the gatekeeper can be limited to those authorized such passage.

In one embodiment, the gatekeeper 85 is linked by a communications link 87 to a subscriber database 90 within a main office 92. The main office 92 may receive information subscription inquiries from parties desiring to be authorized parties, such as breeders 94, pharmaceutical companies 96 and banks 98. If the terms established by principals within the main office 92 are agreeable to such potential authorized parties, and if such potential authorized parties satisfy the agreed upon terms, information specific to the newly authorized party is entered into the subscription database 90. When such newly authorized party, such as a pharmaceutical company 96, for instance, attempts to access the records database 80, the gatekeeper 85 inquires as to the authority of the pharmaceutical company 96 to gain access by checking the subscriber database 90. If the pharmaceutical company 96 is an authorized subscriber, the gateway 85 permits communicative interconnection to the records database 80. Had the pharmaceutical company 96 not been determined to be an authorized user, the gateway 85 would have denied access.

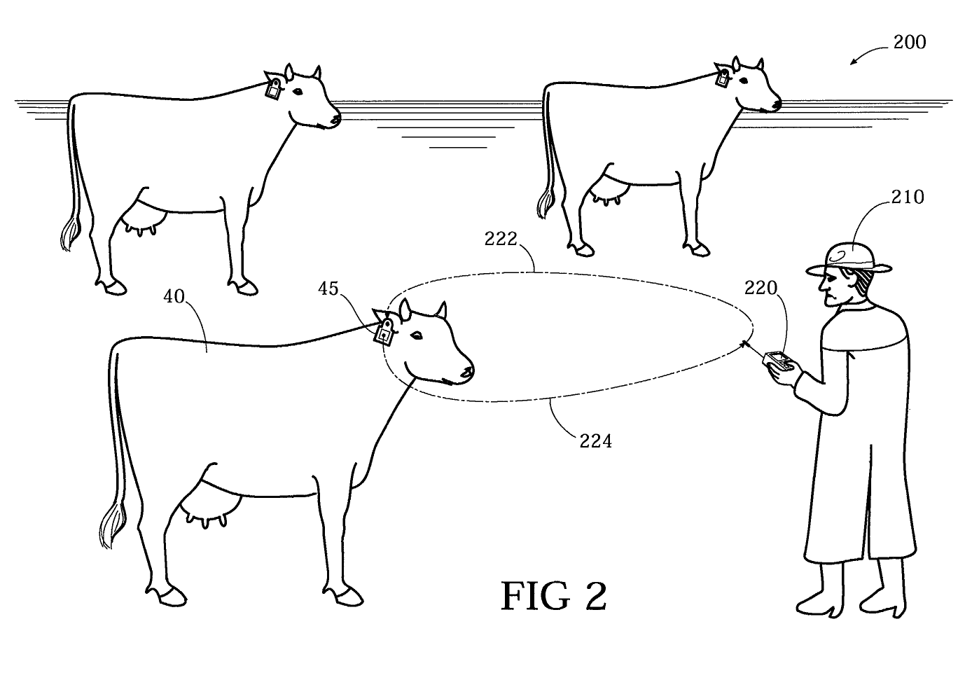

Returning now to more direct discussion of the implementation of the present invention, FIG. 2 depicts a field environment 200—remote from the injection arena 30—in which many animals such as animal 40 may be grazing. If an individual such as a veterinarian 210 (or any other individual, for that matter) desires to determine which medicines an animal such as animal 40 has received without going through the access process described immediately above, he may obtain a receiver unit 220 and approach the animal directly.

The receiver unit 220 is ideally battery or solar powered, so as to avoid the necessity for its use in close proximity to a power source. The receiver unit is of the type well known to those of skill in the art of RF transceivers, and simply communicates (over short range) with the RWRFID 45 to obtain the event information stored thereon. If the RWRFID is an active device, meaning that it continually transmits necessary information, then the receiver unit 220 may, truly be simply a receiver. On the other hand, if the RWRFID is a passive device, the receiver unit 220 may need to generate a stimulus signal 222 before the RWRFID 45 will transmit event information 224 stored thereon.

In one embodiment of the present invention, the receiver unit 220 simply communicates with the RWRFID 45 and displays the event information stored thereon. In another embodiment, the receiver unit 220 may allow the veterinarian 210 (or other user) to write information to the RWRFID 45 in a manner similar to the transceiver syringe 50. This capability is particularly useful when the veterinarian 210 makes a diagnosis and desires to administer a medicine or other treatment to an animal 40, and desires for the medical treatment to be recorded in the event records for the animal 40.

In such a situation where an individual such as a veterinarian 210 administers a treatment other than with the automatically recording transceiver syringe 50, the RWRFID will contain event information different from that stored in the database that was only populated by event information from the transceiver syringe 50. Such discrepancies are addressed by a comparison, upon use of the transceiver syringe 50 of the information residing in the database with information residing on the RWRFID. If a discrepancy is detected, a simple synchronization process—well known to those skilled in the art of computer file reconciliation—is performed, and both storage locations are updated.

Also, because of the bar-code reader/recorder and the UPC codes built into the Records D/B 80 (FIG. 1), the veterinarian can have a system that will prevent the administration of conflicting medicines. For example the RWRFID will have recorded a Baytril® injection one day prior. The Veterinarian will not want to administer Baytril® or Micotil® a conflicting medicine that could have lethal ramifications.

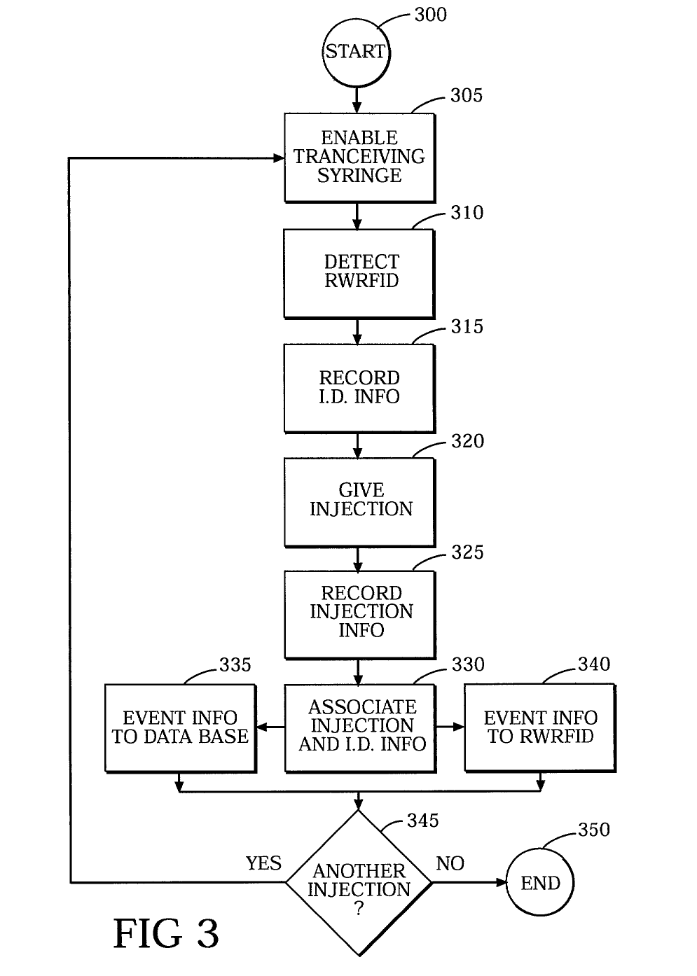

Referring now to FIG. 3, an exemplary method for implementation of the present invention is illustrated. The method of FIG. 3 begins at step 300 and, at step 305, the transceiving syringe 50 is enabled. Enablement of the transceiving syringe may be, as previously described, by the cattleman entering certain input, such as his identification information and the like into a computer controlling the system 5, or it may be as basic as turning on a switch on the transceiving syringe 50. In any event, the enabled transceiving syringe 50 searches for a RWRFID 45 until one is detected at step 310. Detection of the RWRFID 45, also previously discussed, differs depending on whether the RWRFID 45 is an active or passive device. If the RWRFID 45 is an active device, the enabled transceiving syringe 50 will detect it when it comes into receiving range of the signal emitted by the RWRFID 45. If, on the other hand, it is a passive device, it will be detected when the transceiving syringe 50 comes close enough to the RWRFID 45 to excite it with a stimulus signal, then read the resulting transmission. Either way, after the RWRFID 45 has been detected, the identification information received therefrom is recorded, as shown at step 315.

At step 320, an injection is delivered from the transceiving syringe 50 to the animal 40. Essentially simultaneous to the injection at step 320 is the recording of the injection at step 325. In one embodiment of the present invention, the recording step 325 indicates a temporary recording of the injection information in a location such as a temporary memory cache within the transmitting syringe or PDD 56. Once this injection information has been temporarily recorded, it is, at step 330, associated (or linked) with the identification information obtained from the RWRFID 45 positively identifying the animal 40 to which the injection was given.

The method continues at step 335 where the association of the injection information and the identification information (referred to as “event information”) is transmitted or relayed to a computer database such as the PDD 56. At step 340, the event information is transmitted to the RWRFID 45, where it is automatically stored in accordance with an object of the present invention.

At decision block 345, an inquiry is made as to whether another animal is to be injected. If “Yes”, the method returns to step 305 and the process is reinitiated. If “No”, the method ends at step 350.

It will be understood and appreciated that the spirit and scope of the present invention is not limited to the particular embodiments referenced and discussed herein, but to the claims appended hereto.

I claim:

1. A system for automatic, redundant recording of information relating to administration of medicines to animals, comprising:
a read/write radio frequency identification device (RWRFID), attached to the animal and functional to transmit identification information relating to the animal and further functional to receive and store injection information relating to an injection given to the animal; and
a transceiving syringe for injecting the animal, the transceiving syringe further functional to receive identification information relating to the animal from the RWRFID, transmit injection information relating to the animal to the RWRFID, and relay the injection information and the identification information relating to the animal to a computer database, said computer database for maintaining the injection information and the identification information.

2. The system of claim 1, wherein the computer database is integral to the transceiving syringe.

3. The system of claim 1, wherein the RWRFID is an ear tag attached to an ear of the animal.

4. The system of claim 1, wherein the RWRFID is an active device.

5. The system of claim 1, wherein the RWRFID is a passive device.

6. The system of claim 1, wherein the RWRFID transmits identification information relating to the animal responsive to receiving a stimulus signal from the transceiving syringe.

7. A method for automatic, redundant recording of information relating to administration of medicines to animals, comprising the steps of:
identifying an animal by electronically detecting identification information relating to the animal, the identification information being stored on and transmitted from a read/write radio frequency identification device (RWRFID) attached to the animal;
delivering an injection to the animal by a transceiving syringe;
recording, via the transceiving syringe, injection information relating to the injection given to the animal;
associating, as event information, the injection information relating to the injection given to the animal with the identification information relating to the animal;
transmitting the event information to the RWRFID for storage on the RWRFID; and
relaying the event information to a computer database for storage.

8. The method of claim 7, comprising the further step of providing, responsive to a request, the event information stored on the RWRFID.

9. The method of claim 7, wherein the step of recording the injection information contains the further steps of determining and recording the date of the injection.

10. The method of claim 7, wherein the step of recording the injection information contains the further steps of determining and recording the internal body temperature of the animal.

11. The method of claim 7, wherein the step of recording the injection information contains the further steps of determining and recording the amount of medicine delivered during an injection.

12. The method of claim 7, wherein the step of recording the injection information contains the further steps of determining and recording the identity of the medicine given to the animal.

13. The method of claim 7, further comprising the steps of:
delivering a second injection to the animal by the transceiving syringe;
recording, via the transceiving syringe, second information relating to the second injection given to the animal;
associating, as second event information, the second injection information relating to the second injection given to the animal with the identification information relating to the animal;
transmitting the second event information to the RWRFID for storage on the RWRFID; and
relaying the second event information to a computer database for storage.

14. A read/write radio frequency identification device (RWRFID) attached to an animal and functional to transmit identification information relating to the animal and further functional to receive and store information relating to an injection given to the animal.

15. The RWRFID of claim 14 wherein the injection information received and stored on the RWRFID is transmitted by a transceiving syringe.

16. The RWRFID of claim 14 wherein the identification information and injection information stored on said RWRFID is duplicated on a separate computer database.

17. A RWRFID having received and stored thereon injection information from a first occurrence of administering medicine to an animal, and also having received and stored thereon injection information from a second occurrence of administering medicine to an animal.

18. The RWRFID of claim 17 wherein both occurrences of received and stored injection information were transmitted by a transceiving syringe.
